(19) United States
(12) Patent Application Publication
(10) Pub. No.: US 2005/0274026 A1
(43) Pub. Date: Dec. 15, 2005

(54) Vinyl pack opener

(76) Inventor: Gu-Ha Lee, Seoul (KR)

Correspondence Address: GWIPS;PETER T. KWON, 1600-3 SEOCHO-DONG, SEOCHO-GU,, DAELIM BUILDING, 9TH FLOOR, SEOUL, 137-877, KR

(21) Appl. No.: 10/532,622

(22) PCT Filed: Oct. 29, 2003
(86) PCT No.: PCT/KR03/02301

§ 371 Date: Apr. 25, 2005

(30) Foreign Application Priority Data
Nov. 2, 2002 (KR) 20-2002-0032841

(51) Int. Cl. B26B 29/00

(52) U.S. Cl. 30/294

(57) ABSTRACT

Disclosed is a vinyl pack opener for easily and quickly opening pouches containing traditional oriental medicines and various kinds of fruit juices therein, or securely sealed bags or vinyl packs in which contents such as synthetic detergents for refills are packed. The vinyl pack opener includes: a body (10) having a guide space (20) formed therein, the guide space having an opening part (21) at the front portion thereof; a cutter (30) provided at the rear portion of the opening part (21), for cutting a vinyl pack put in the opening part (21) of the guide space (20); and cutting resistance reducing means provided in the guide space (20), for reducing the cutting resistance of the vinyl pack being cut by the use of the cutter (30).

### TECHNICAL FIELD

The present invention relates to a vinyl pack opener for easily and quickly opening pouches containing traditional oriental medicines and various kinds of fruit juices therein, or securely sealed bags or vinyl packs in which contents such as synthetic detergents for refills are packed.

### BACKGROUND ART

Generally, securely sealed vinyl packs in which contents are packed such as pouches containing traditional oriental medicines and various kinds of fruit juices therein are easy to carry and to be kept at predetermined places. However, these vinyl packs are sealed so securely that they are difficult to open without a knife or scissors. In case of using the knife to open the vinyl packs, however, it is difficult for even adults to cut and open the pack along a relatively constant line, or sometimes it may be a hard work. In case of using the scissors, on the other hand, the packs can be cut along a relatively constant line, but they should be always carried together with the packs, which of course gives inconveniences in use. According to common practice, in case of attempting to open the oriental medicine pack at the office, it is liable to cut it by use of the scissors for work, and in case of attempting to open the synthetic detergent pack for a refill at home, it is necessary to wash the scissors after use or to prepare several pairs of scissors for various purposes.

To address the aforementioned problems, there have been proposed a conventional vinyl pack opener that is provided with a guide space of a straight line or a curved line that is formed into a synthetic resin body and with a cutter that is fixed in the guide space. However, the sharp portion of the pack that has been first cut is caught by the opener body which is thicker than the cutter or excessive forces are applied upon cutting such that the contents packed in the packs are often spilt.

### DISCLOSURE OF INVENTION

Accordingly, the present invention has been made to solve the above-described problems, and it is an object of the present invention to provide a vinyl pack opener that can open a vinyl pack at a predetermined cutting angle at which the vinyl pack is cut well, while a user' finger does not touch a cutter, such that it is easy and safe to carry together with the vinyl pack, and that can open the vinyl pack under the application of a constant force irrespective of whether the user is a left-handed person or a right-handed person, without having any temporary stopping, such that the contents in the vinyl pack can be poured without any loss.

To achieve the above object, according to the present invention, there is provided a vinyl pack opener including: a body having a guide space formed therein, the guide space having an opening part at the front portion thereof; a cutter provided at the rear portion of the opening part, for cutting a vinyl pack put in the opening part of the guide space; and cutting resistance reducing means provided in the guide space, for reducing the cutting resistance of the vinyl pack being cut by the use of the cutter.

### BRIEF DESCRIPTION OF THE DRAWINGS

Further objects and advantages of the invention can be more fully understood from the following detailed description taken in conjunction with the accompanying drawings, in which:

FIG. 1 is a perspective view showing one side of a vinyl pack opener according to a present invention;

FIG. 2 is a perspective view showing the other side of the vinyl pack opener;

FIG. 3 is a partial perspective view showing an upper portion of the vinyl pack opener;

FIG. 4 is a front view showing one side body member of the vinyl pack opener;

FIG. 5 is a front view showing the other side body member of the vinyl pack opener;

FIG. 6 is a sectional view of the part around a protrusion of the vinyl pack opener;

FIG. 7 is an exploded perspective view of the vinyl pack opener that is associated with FIG. 6;

FIG. 8 is a sectional view of the part around a protrusion of the vinyl pack opener, where the position of the protrusion is changed; and

FIG. 9 is an exploded perspective view of the vinyl pack opener that is associated with FIG. 8.

### BEST MODE FOR CARRYING OUT THE INVENTION

Now, an explanation of the preferred embodiment of the present invention will be in detail given with reference to attached drawings. In this preferred embodiment, the parts corresponding to the drawings are indicated by like reference numerals.

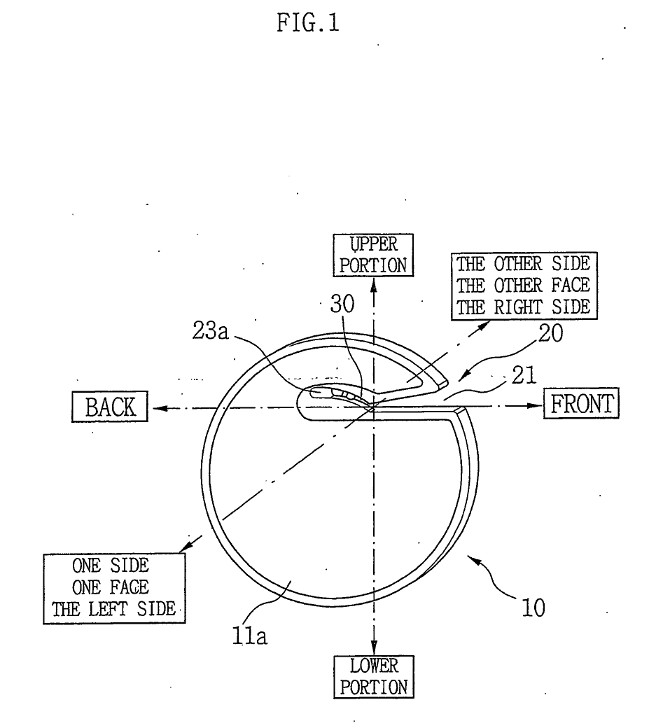

The directions as will be described in the preferred embodiment of this invention are defined by the coordinates indicated by one-dotted broken lines as shown in FIG. 1. In more detail, the direction where an opening part 21 is formed is defined as the front with respect to a guide space 20, the direction opposite to the front is defined as the back with respect to the guide space 20. The direction where the guide space 20 is formed somewhat upwardly in a vinyl pack opener 10 is defined as the upper portion, and the direction opposite to the upper portion is defined as the lower portion. The guide space 20 is in a shape of a straight line at the front and in a curved shape at the back, which is defined as one side, one face or left side with respect to a cutter 30, and the opposite face of the guide space 20 to one side, one face or left side is defined as the other side, the other face, or the right side with respect to the cutter 30.

The vinyl pack opener according to the preferred embodiment of this invention is characterized in that it is very easy to carry and that a guide space has a structure that prevents the user from having his or her finger cut.

The key point of the characteristics of this invention is placed in that the cutting resistance of the cutter occurring upon cutting is dramatically reduced so that the vinyl pack can be cut gently and smoothly until it is completely cut.

According to the preferred embodiment of the present invention, such the cutting resistance reducing means is embodied with three main functions. In other words, the first function of the cutting resistance reducing means is to separate left and right the vinyl pack end portion that is cut as it goes toward the back from the front of the edge of the cutter. As a result, the front end of the vinyl pack cannot be caught by the stepped projections on the guide space 20 of the opener body 10. In the preferred embodiment of the present invention, the means having the first function is called ‘left/right separating means’.

The second function of the cutting resistance reducing means is to separate the left and right shapes of the guide space 20 to be different around the cutter 30, such that the vinyl pack is opened upwardly and downwardly along the guide space 20. As a result, even though the same force is applied, the vinyl pack can be cut in an easier manner than when cut to a straight line, without any separation in upward and downward directions. In the preferred embodiment of the present invention, the means having the second function is called ‘an upward/downward separating means’

Furthermore, the third function of the cutting resistance reducing means is embodied by a predetermined fixed angle of the cutter 30. In the embodiment, the predetermined fixed angle of the cutter 30 with respect to the vinyl pack to be inserted into the opening part 21 is set to be 90 degrees or less.

The left/right separating means, the upward/downward separating means, and the predetermined fixed angle of the cutter 30 are employed individually or combined with one another in the embodiment of the present invention.

Now, the aforementioned characteristics of the vinyl pack opener of this invention will be in detailed described.

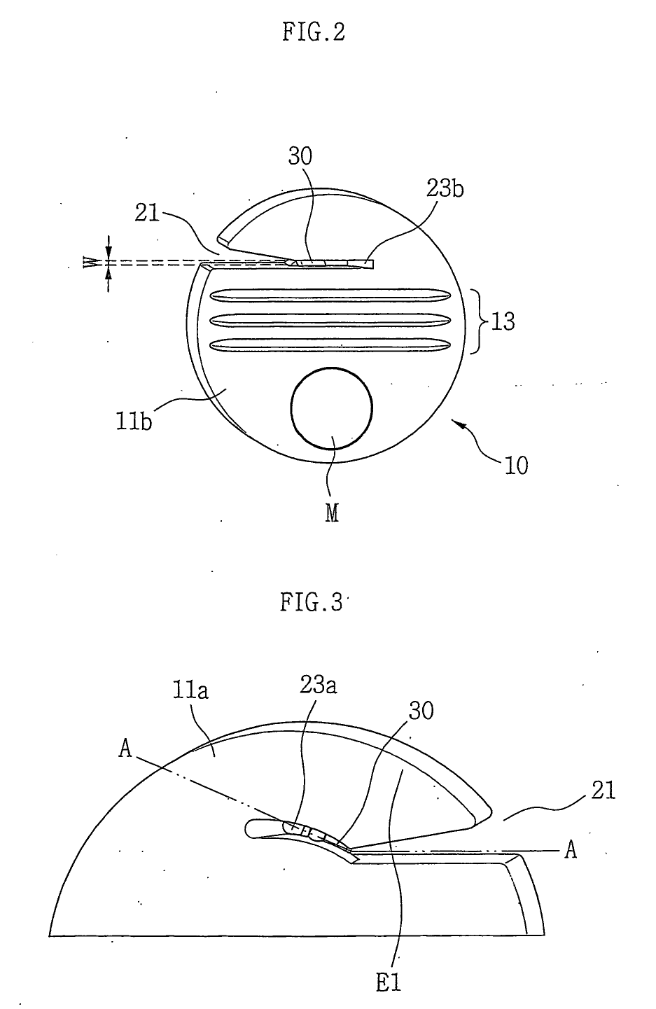

As shown in FIGS. 1 and 2, the upward/downward separating means of the cutting resistance reducing means as one of the principal parts of the vinyl pack opener of this invention is employed with the guide space 20 that is configured in different manners at one side 11a of the opener body 10 and at the other side 11b thereof with respect to the cutter 30.

As illustrated in FIG. 1, the guide space 20 of the opener body 10 is in a straight line from the opening part 21 to the cutter 30. Especially, the opening part 21 is configured in such a manner as to be gradually reduced in width as it goes toward the inside thereof.

The guide space 20 has the different shapes at the back of the cutter 30. That is to say, the guide space 20 is provided with an upwardly curved part 23a at one side thereof (see FIG. 1) and with a straight line part 23b at the other side thereof (see FIG. 2).

This shows an example of the application of the upward/downward separating means. Alternately, the guide space 20 may be provided with upwardly and downwardly curved spaces at the both sides thereof or with upwardly and downwardly inclined straight line spaces at the both sides thereof.

Desirably, the guide space 20 is tapered in such a manner as to have the same plane as the both sides of the opener body 10 as it becomes high at the back of the cutter 30. This shows the combination of the left/right separating means to the upward/downward separating means.

In FIG. 2, the guide space 20 is desirably formed in such a manner as to have a relatively small minimum width W, which prevents a user from having his or her finger cut.

In consideration of the person's finger shape, the minimum width W is more desirably set to be under 2 mm and most desirably, set to be between 0.1 mm and 2 mm, which prevents the user's finger from being forced into the guide space 20.

At the other side 11b or at both sides 11a and 11b of the opener body 10, in addition, there is provided a concavo-convex part 13 that prevents the opener itself from slipping. In this case, the concavo-convex part 13 is formed of some protrusions or grooves.

To satisfy the intentions of the producers, sellers, and advertisers of various kinds of vinyl packs, preferably, one side 11a of the opener body 10 has no irregular portion on the surface thereof, such that a predetermined advertisement is attached in a shape of a sticker or a print. Alternately, the advertisement may be achieved in a raised relief or bas-relief manner in a mold itself.

A reference numeral M in FIG. 2 indicates a magnet that is laid under the opener body 10, which enables the opener to be kept with ease at a predetermined place.

Next, an example of the application of the left/right separating means of the cutting resistance reducing means of the vinyl pack opener of this invention will be described.

The left/right separating means as shown in FIG. 3 is employed with a protrusion E1 that is formed around the cutter 30. Preferably, the protrusion E1 takes a shape of a wedge such that it becomes thicker as it goes toward the back of the edge of the cutter 30.

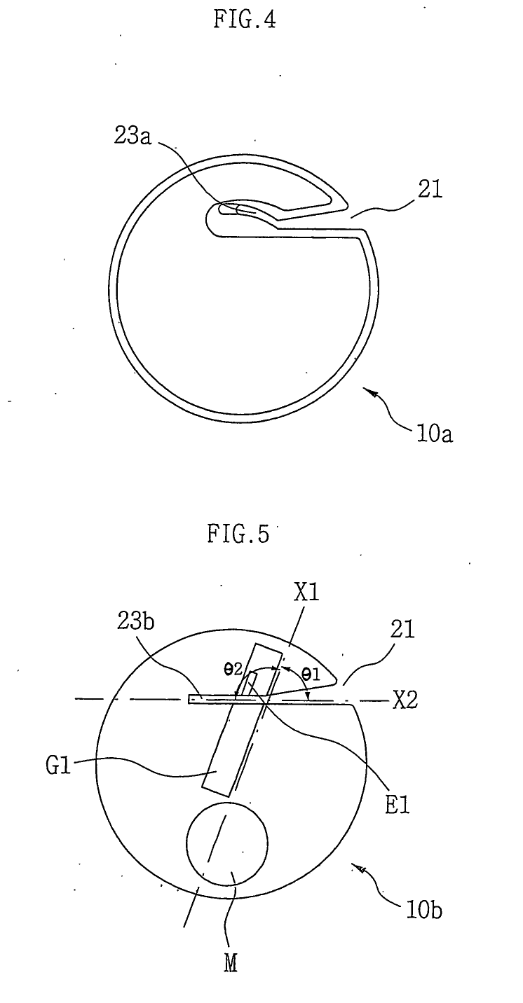

FIGS. 4 and 5 show the vinyl pack opener of this invention wherein two body members 10a and 10b are coupled to form the opener body itself, which makes it easy to manufacture the vinyl pack opener.

One side body member 10a as shown in FIG. 4 has the guide space 20 with a curved part 23b at the back of the cutter 30. And, the other side body member 10b corresponding to one side body member 10a, as shown in FIG. 4 has the guide space 20 with a straight line part 23b at the back of the cutter 30. With the two parts 23a and 23b of the guide space 20, the function of the aforementioned upward/downward separating means can be achieved.

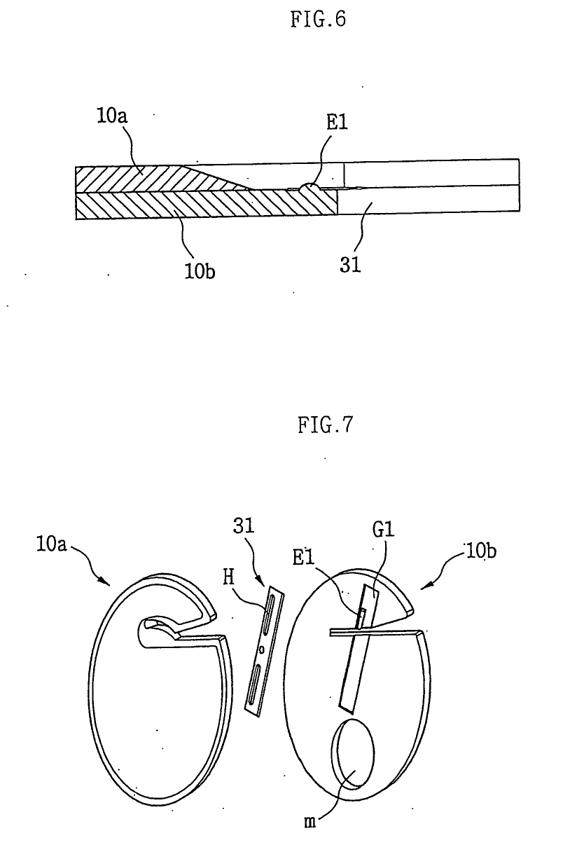

Next, the left/right separating means is employed with the protrusion E1 that is formed in a cutter receiving groove G1 located on the other side body member 10b, as shown in FIG. 5. The protrusion E1 is inserted into an insertion hole H of the cutter 31, as shown in FIGS. 6 and 7, and is exposed to the guide space 20 of one side body member 10a upon the coupling between the two body members 10a and 10b.

FIG. 6 shows the view when the opener of this invention is cut in the same direction as the two-dotted broken line A-A in FIG. 3. A reference numeral m in FIG. 7 indicates a magnet receiving groove on the other side body member 10b.

Next, an explanation of the predetermined fixed angle of the cutter 30 as one of the characteristics of the cutting resistance reducing means will be given with reference to FIG. 5.

The predetermined fixed angle of the cutter 30 is determined by means of the cutter receiving groove G1 that is formed on the other side body member 10b. A vertical axis X1 of the cutter receiving groove G1 (which means the vertical axis of the cutter 30) is not at a right angle but at an acute angle with respect to an imaginary straight line axis X2 that defines an advancing direction of the vinyl pack inserted into the guide space 20 through the opening part 21. This allows the vinyl pack to be cut with ease.

The present inventor has found the range of the acute angles of the cutter where the vinyl packs are cut with ease. The angle θ1 between the axes X1 and X2 is desirably between 68 degrees and 75 degrees.

The fact that the angle between the axes X1 and X2 is the acute angle has been proved with the same results when the opener of this invention is used upside down, and therefore, the opener having an acute angle θ2 is included in the scope of this invention.

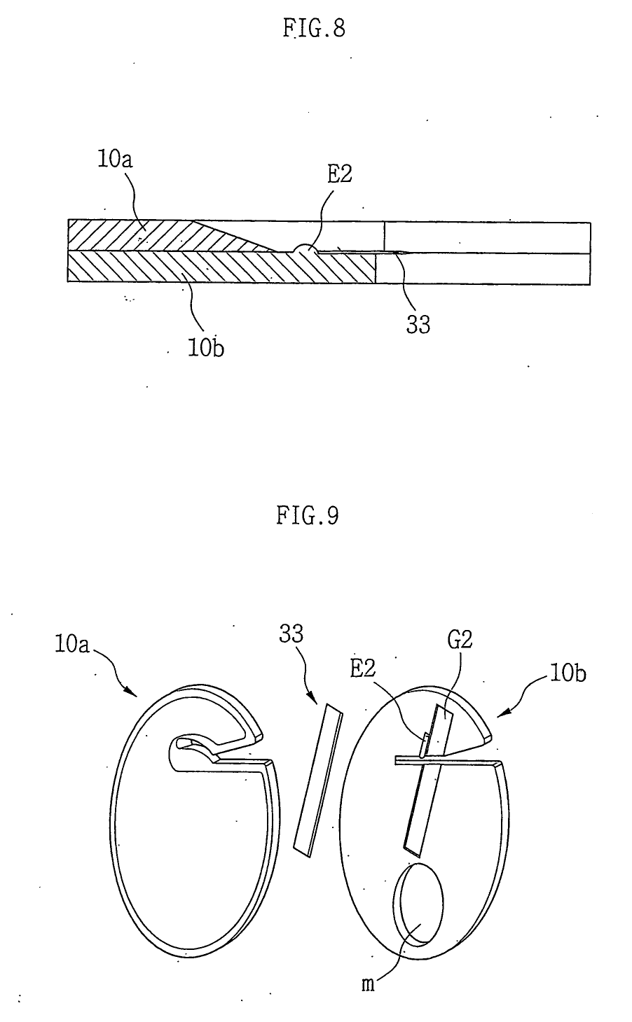

FIGS. 8 and 9 show another example of the protrusion employed as the left/right separating means of this invention. FIG. 8 shows the view when the opener of this invention is cut in the same direction as the two-dotted broken line A-A in FIG. 3.

Unlike the protrusion E1 as shown in FIGS. 6 and 7, the protrusion E2 as shown in FIGS. 8 and 9 is protruded at the back of the cutter receiving groove G2. Upon the coupling between the two body members 10a and 10b, therefore, the protrusion E2 is exposed to the guide space of the other side body member 10a. The cutter 33 used in the opener having the protrusion E2 can be replaced with one typically used as school things. Therefore, when the cutter 33 gets dull, it can be exchanged with a new one.

In addition thereto, another example of the left/right separating means may be employed with the opener body 10 or the cutter 30 that becomes gradually thicker as it goes toward the back of the edge of the cutter 30.

Industrial Applicability

As set forth in the foregoing, there is provided the vinyl pack opener of the present invention that is provided with the cutting resistance reducing means having the upward/downward separating means, the left/right separating means, and the predetermined fixed angle of the cutter, each of which being combined with one another or individually embodied. Referring to the example according to the present invention where the upward/downward separating means, the left/right separating means, and the predetermined fixed angle of the cutter are combined with one another, as the edge of the vinyl pack is passed through the opening part 21 of the guide space 20 of the opener body 10, it starts to cut by means of the cutter 30 located at angles θ1 and θ2 between 68 degrees and 75 degrees. On the right side of the cutter 30, thus, the vinyl pack moves in a straight line along the straight line part 23b of the guide space 20 of the other side body member 10b. On the left side of the cutter 30, however, the edge of the vinyl pack moves at a curved angle along the curved part 23a of the guide space 20 of one side body member 10a and gets opened gradually from the cutter 30 by means of the protrusion E1, E2 on the cutter 30. Thus, the edge portion cut is not caught by the opener body 10 part at the back of the guide space 20 that is typically thicker than the cutter 30, such that the vinyl pack can be easily cut.

Also, the width of the guide space 20 is so small that a user's hand cannot directly touch the cutter 30. And, the concavo/convex part 13 is provided on the other side 11b of the opener body 10 for the purpose of preventing the opener from slipping, so that it can be carried in a safe, convenient manner.

In addition, the opener body 10 is formed of one side body member 10a and the other side body member 10b for the purpose of achieving the easiness of the production, and if it is made of synthetic resin, it is light and has a low production cost. Further, one side 11a of the opener body 10 is employed as an advertising area for a predetermined advertisement.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

1-14. (canceled)

15. A vinyl pack opener comprising:
a body (10) forming a guide space (20), said guide space having an opening part (21) at the front portion;
a cutter (30) provided at the rear portion of said opening part (21) for cutting a vinyl pack guided into said opening part (21) of the guide space (20), and
cutting resistance reducing means provided in the guide space (20) for reducing the cutting resistance of the vinyl pack being cut by using the cutter (30).

16. A vinyl pack opener as claimed in claim 15, wherein the cutting resistance reducing means comprises a vertically separating means for separating the vinyl pack upward and downward along with cutting, said vertically separating means being constructed to have the guide space (20) formed upwardly and downwardly to cross each other at the left and right sides of the cutter (30) as the guide space (20) goes toward the back of the cutter (30).

17. A vinyl pack opener as claimed in claim 15, wherein the cutting resistance reducing means comprises a laterally separating means for separating the vinyl pack leftward and rightward along with cutting, the laterally separating means being constructed to have a protrusion formed on the cutter (30).

18. A vinyl pack opener as claimed in claim 15, wherein the cutting resistance reducing means comprises a vertically separating means constructed to have the guide space (20) formed upwardly and downwardly to cross each other at the left and right sides of the cutter (30) as the guide space goes toward the back of the cutter (30), and laterally separating means constructed to have a protrusion formed on the cutter (30).

19. A vinyl pack-opener as claimed in claim 16, wherein the vertically separating means is constructed in such a manner that the guide space (20) has an upwardly curved part (23a) formed at one side of the cutter (30) and a straight line part (23b) formed at the other side of the cutter (30).

20. A vinyl pack opener as claimed in claim 17, wherein the laterally separating means is constructed in such a manner that the protrusion (El) formed in a cutter receiving groove (G1) for the cutter (31) on one side body member (10b) of the opener body (10) consisting of two body members (10a, 10b) is inserted into an insertion hole (H) of the cutter (31) such that it is exposed to the guide space (20) of the other side body member (10a) upon the coupling between one side body member (10b) and the other side body member (10a).

21. A vinyl pack opener as claimed in claim 17, wherein the laterally separating means is constructed in such a manner that the protrusion (E2) formed at the back of a cutter receiving groove (G2) for the cutter (33) on one side body member (10b) of the opener body (10) consisting of two body members (10a, 10b) is exposed to the guide space (20) of the other side body member (10a) upon the coupling between one side body member (10b) and the other side body member (10a).

22. A vinyl pack opener as claimed in claim 15, wherein the cutting resistance reducing means comprises laterally separating means for separating the vinyl pack leftward and rightward along with cutting, the laterally separating means being constructed to have the opener body (10) or the cutter (30) become gradually thicker as it goes toward the back of the edge of the cutter (30).

23. A vinyl pack opener as claimed in claim 15, wherein a vertical axis (X1) of the cutter (30) is at acute angles (θ1, θ2) with respect to an imaginary straight line axis (X2) that defines an advancing direction of the vinyl pack inserted into the guide space (20) through the opening part (21).

24. A vinyl pack opener as claimed in claim 23, wherein the angles (θ1, θ2) between the vertical axis (X1) and the imaginary straight line axis (X2) each are between 68° and 75°.

25. A vinyl pack opener as claimed in claim 15, wherein the guide space (20) has opening with width (W) in a range of 0.1 mm to 2 mm for protecting user's finger.

26. A vinyl pack opener as claimed in claim 15, wherein the opener body (10) having front and rear surfaces (11a, 11b) forms concavo-convex part (13) on one side or both sides for preventing the slipping.

27. A vinyl pack opener as claimed in claim 15, wherein the opener body (10) has a front surface (11a) for placing an advertisement and a rear surface (11b) with concavo-convex part (13) for preventing the slipping.

28. A vinyl pack opener as claimed in claim 15, wherein the opener body (10) has a magnet inside the opener body (10) for easily keeping at a convenient place.
